(19) United States
(12) Patent Application Publication
(10) Pub. No.: US 2008/0290691 A1
(43) Pub. Date: Nov. 27, 2008

(54) Lightweight plastic vehicles

(75) Inventors: Jeffrey James Corsiglia, Toronto (CA); Charles Sink, Friday Harbor, WA (US)

Correspondence Address: COHEN, PONTANI, LIEBERMAN & PAVANE LLP, 551 FIFTH AVENUE, SUITE 1210, NEW YORK, NY, 10176, US

(73) Assignee: Spin Master Ltd., Toronto (CA)

(21) Appl. No.: 11/807,234

(22) Filed: May 25, 2007

(51) Int. Cl. B62D 29/04

(52) U.S. Cl. 296/181.2

(57) ABSTRACT

A vehicle with a novel vehicle body formed of polyvinylchloride plastic (“PVC”) or similar plastics. Generally, the vehicle body is formed by folding or vacuum forming one or more sheets of PVC into shapes specific to one type of vehicle. The type of vehicle can be any type of vehicle, including planes, cars, trains, tanks, of the like. The vehicle body also incorporates novel structural elements such as curves, folds or troughs that stiffen the PVC and facilitate assembly of the vehicle body.

### BACKGROUND OF THE INVENTION

1. Field of the Invention

This invention relates in general to lightweight plastic vehicles and in particular to plastic toy vehicles.

2. Description of the Related Art

Vehicles, in particular, toy vehicles, with vehicle bodies made out of plastic are well known in the art. For example, U.S. Pat. No. 2,870,567 describes a model airplane with various components made from extremely thin polystyrene plastic, typically vacuum formed to achieve the required configuration. U.S. Patent Application No. 2005/0227582 discloses a model airplane constructed of an expanded polypropylene foam plastic core with a thin semi-rigid polycarbonate plastic shell adhesively attached to the core. U.S. Pat. No. 6,685,528 discloses the fabrication of a flyable plastic airplane by joining two vacuum-formed plastic portions.

One problem with such plastic vehicles is that the vehicle bodies are often made of dense and/or thick plastic. The vehicle bodies may also incorporate independently formed support elements made of dense and/or thick plastics and even non-plastic materials such as wood and metal. These support elements are necessary to give the vehicle sufficient rigidity, but increase the weight of the vehicles, the cost of materials and also the complexity of the manufacturing process.

The cost of manufacturing plastic vehicles can be reduced by using lighter, less expensive plastics for vehicle bodies and by eliminating independently formed support elements. The cost can also be reduced by using less plastic. However, these approaches to reducing the cost of manufacture can produce vehicle bodies that are flimsy and unable to perform their intended function. For example, forming the wings and other aerodynamic surfaces of a toy airplane from plastic that is too flexible can cause serious instability during flight.

### SUMMARY OF THE INVENTION

The lightweight plastic vehicles described herein by the applicants seek to overcome the deficiencies of the prior art by providing vehicles with novel vehicle bodies and a method of manufacture. The applicants' lightweight plastic vehicle bodies provide an improvement over the prior art because they are formed from at least one sheet of thin polyvinylchloride plastic (“PVC”) or similar plastic, and incorporate novel structural elements that stiffen the plastic and facilitate assembly of the vehicle bodies.

As used herein, “vehicle body” means the frame, outer walls and any other components that form or support the shape of a vehicle. The vehicle body can be for any type of vehicle, including planes, cars, trains, tanks, and the like.

The vehicle bodies of the applicants' light weight plastic vehicles are formed from PVC plastic, or other similar plastics, which have a number of advantageous properties. PVC is a common, inexpensive and lightweight thermoplastic resin that is commonly used in the retail industry to construct blister pack or bubble wrap display packaging. Another property of PVC is that it can accept a “dead fold”, which means that a sheet of PVC has the ability to retain its shape once it is folded and will not spring back to an unfolded state. PVC can also be transparent. With transparent PVC, it is possible to reverse print on the underside of PVC sheets such that photographically detailed images can be seen through the plastic. The transparent PVC layer provides a “clear coat” effect, making the detailed images very glossy and attractive. Foam plastic cannot match this effect.

The applicants' lightweight plastic vehicle body can also include structural elements that stiffen its constituent sheet or sheets of PVC. A description of these structural elements follows. First, strategically placed creases or folds can stiffen sheets of PVC. For example, the edge of a PVC sheet can be folded under the sheet; the fold and the additional PVC thickness creates a stiffening support along the edge of the PVC sheet. Similarly, vacuum forming curves and compound curves in sheets of PVC can stiffen the sheets.

Second, troughs or grooves in PVC sheets can stiffen the sheets. The troughs or grooves can be formed in a PVC sheet by folding or vacuum forming. Additional stiffness can be achieved by covering at least part of a trough or groove with tape or a label, which helps prevent flexing of the PVC sheet.

Third, a structure that is much stiffer than a single thin sheet of PVC can be produced by forming two PVC sheets, representing a first portion and a second portion of a vehicle body, and then joining the sheets to form a rigid tube or other complex shape. Preferably, the PVC sheets overlap where there are points of flexure in the vehicle body. For example, when the vehicle is an airplane, there are points of flexure where the wings of the airplane meet the fuselage. In this example, PVC sheets representing the top and bottom halves of the airplane would preferably extend over a least part of the airplane's wings.

The vehicle body can further include structural elements that facilitate assembly of the vehicle body. First, matching dimples or other nesting shapes formed in upper and lower halves of a vehicle body can allow the halves to be easily aligned and fastened at these dimples. In addition to providing location during assembly, the dimples also increase stiffness by preventing sliding between the upper and lower halves. Second, PVC sheets can be formed with indents adapted to receive the vehicle's internal components and hold them in a predetermined location and alignment. The dimples and/or indents can be formed while vacuum forming the PVC sheets.

According to one aspect then, there is provided a lightweight vehicle comprising: a vehicle body; wherein the vehicle body comprises at least one sheet of plastic, the plastic sheet made from one of polyvinylchloride plastic, polycarbonate plastic, butyrate plastic or combinations thereof. The vehicle body may be formed by at least one of folding or vacuum forming. The sheet of plastic used to form the vehicle body may be between about 0.005 and 0.05 inches thick and preferably between about 0.005 and 0.015 inches thick. The stiffness modulus of the sheet of plastic may be in a range of between about 306,000 psi and about 414,000 psi. The sheet of plastic may be transparent to permit an image to be reverse printed on the sheet. The sheet of plastic may include at least one fold, trough or vacuum formed curve to stiffen the sheet. The trough or the fold may be at least partially covered by tape or a label. The sheet may include indents adapted to receive the vehicle's internal components and hold them in a predetermined location and alignment.

The vehicle body may be made up of a first sheet and a second sheet of plastic, the first sheet formed into a first portion of the vehicle body, the second sheet formed into a second portion of the vehicle body, the first and second portions being joined to form the vehicle body. The first and second portions preferably overlap where there are points of flexure in the vehicle body. The first and second portions may be formed with nesting shapes adapted for aligning and joining the first and second portions.

The vehicle may be an airplane, where the sheet of plastic is formed into left and right wing sections; left and right tail sections; and a fuselage. The vehicle may be a ready to fly airplane. The wing sections may be formed with at least one trough to stiffen the wing sections. The tail sections may be formed with at least one trough to stiffen the tail sections. The troughs in the wing sections and the tail sections may be covered by tape or a label. A fold in the sheet of plastic may define leading edges of the wing sections to stiffen the wing sections. A curve may be formed in the sheet of plastic adjacent to leading edges of the wing sections to stiffen the wing sections.

The vehicle body may be made of a first sheet and a second sheet of plastic, the first sheet formed into a first portion of the vehicle body, the second sheet formed into a second portion of the vehicle body, the first and second portions are joined to form the vehicle body. The first and second portions preferably overlap where the wing sections meet the fuselage.

According to another aspect, there is provided a method of manufacturing a lightweight vehicle comprising the steps of: forming a first sheet of a plastic into a first portion of a vehicle body; forming a second sheet of the plastic into a second portion of a vehicle body; securing internal components of the vehicle between the first portion of the vehicle body and the second portion of the vehicle body; and joining the first and second portions of the vehicle body; wherein the plastic sheets are made from one of polyvinylchloride plastic, polycarbonate plastic, butyrate plastic, or combinations thereof.

In the method described above, the first and second portions of the vehicle body may be formed by at least one of folding or vacuum forming. The steps of forming the first sheet and/or the second sheet may include the step of forming at least one curve in the first sheet and/or the second sheet to stiffen the first sheet and/or the second sheet. The steps of forming the first sheet and/or the second sheet may also include the step of forming at least one fold or trough in the first sheet and/or the second sheet to stiffen the first sheet and/or the second sheet. The first and second sheets of plastic may be preferably between about 0.005 and 0.015 inches thick, but may be between about 0.005 and 0.05 inches thick. The stiffness modulus of the first and second sheets of plastic may be in the range of between about 306,000 psi and about 414,000 psi.

Embodiments of the applicants' plastic vehicle bodies as described herein are lightweight and rigid. They are also easy and inexpensive to manufacture, providing significant improvements over the prior art.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred embodiments of the applicants' lightweight plastic vehicles will now be described by way of example and with reference to the accompanying drawings in which:

FIG. 1 is a bottom view of one of the applicants' lightweight vehicles, specifically a plane.

FIG. 2 is a top view of the plane of FIG. 1.

FIG. 3a is a cross-sectional view of a wing section taken along lines 3-3 of FIG. 2, showing a trough.

FIG. 3b is a perspective view of the cross-sectional view of FIG. 3a

FIG. 4 is a cross-sectional view taken along lines 4-4 of FIG. 2, showing the upper and lower sheets forming the fuselage indents.

FIG. 5 is a perspective view of a cross-section of a wing section similar to that shown in FIG. 3a, but showing a groove rather than a trough.

FIG. 6 is a cross-sectional view taken along lines 6-6 of FIG. 2, showing matching dimples in the upper and lower sheets.

### DETAILED DESCRIPTION OF THE PRESENTLY PREFERRED EMBODIMENTS

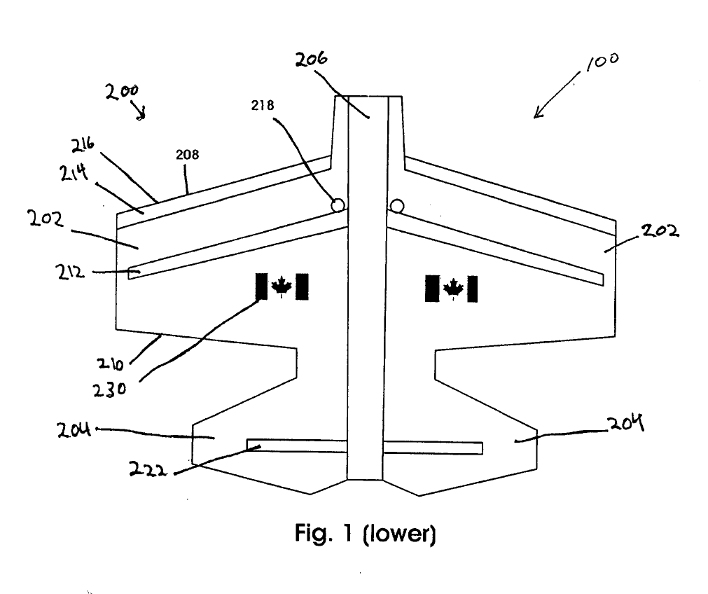

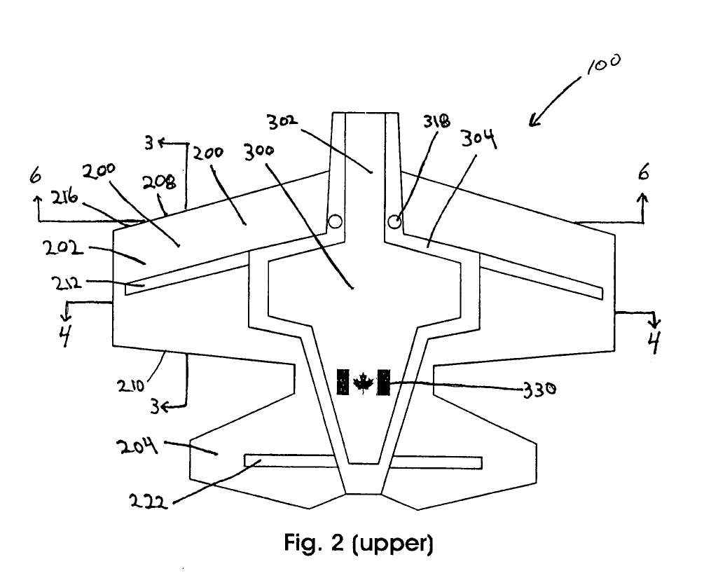

Lightweight plastic vehicles are described herein having a vehicle body formed of a thin plastic sheet capable of being formed by heat. The thin plastic sheet may be PVC plastic. In other embodiments of the plastic vehicles, the plastic can be polycarbonate or butyrate plastic or combinations of all of the above. Generally, the vehicle body is formed by folding or vacuum forming one or more sheets of PVC into shapes specific to one type of vehicle. The type of vehicle can be any type of vehicle, including planes, cars, trains, tanks, and the like. FIGS. 1 and 2 show a plastic vehicle, specifically an airplane 100, according to one embodiment of the applicants' lightweight plastic vehicles.

Airplane 100 comprises two sheets 200, 300 of vacuum formed, transparent PVC. In other embodiments, the PVC is an opaque, coloured plastic. Vacuum forming is a known shaping process wherein a heated plastic sheet is drawn into a cavity or over a model using a vacuum, and then cooled. Vacuum forming is the process generally used in making packaging blisters. The PVC sheets 200, 300 are preferably between about 0.005 and 0.015 inches thick, but may range in thickness from 0.005 to 0.05 inches. In one embodiment, the stiffness modulus of the PVC used by the applicants is about 360,000 psi (“pounds per square inch”) with a variation of about plus or minus 15%, measured on a sheet thickness of about 0.010 to 0.012 inches and based on a test method defined by the American Society for Testing and Materials (ASTM) D-790. The thickness of the vacuum formed sheets can vary because of the vacuum forming process; vertical surfaces tend to draw thinner than horizontal surfaces. In addition, portions of the PVC sheets that will be subjected to stress can be made thicker than portions that are primarily decorative.

The lower PVC sheet 200 represents the bottom half of the airplane and the upper PVC sheet 300 represents the top half of the airplane. A detailed description of the upper and lower PVC sheets follows.

Lower PVC sheet 200 is a continuous sheet comprising wing sections 202, tail sections 204 and a fuselage section 206. Reverse printed on the upper surface of the PVC sheet are photographically detailed images 230 that can be seen through the plastic. The images depict elements common to the underside of an airplane. In other embodiments, the lower PVC sheet is not printed on and is substantially transparent.

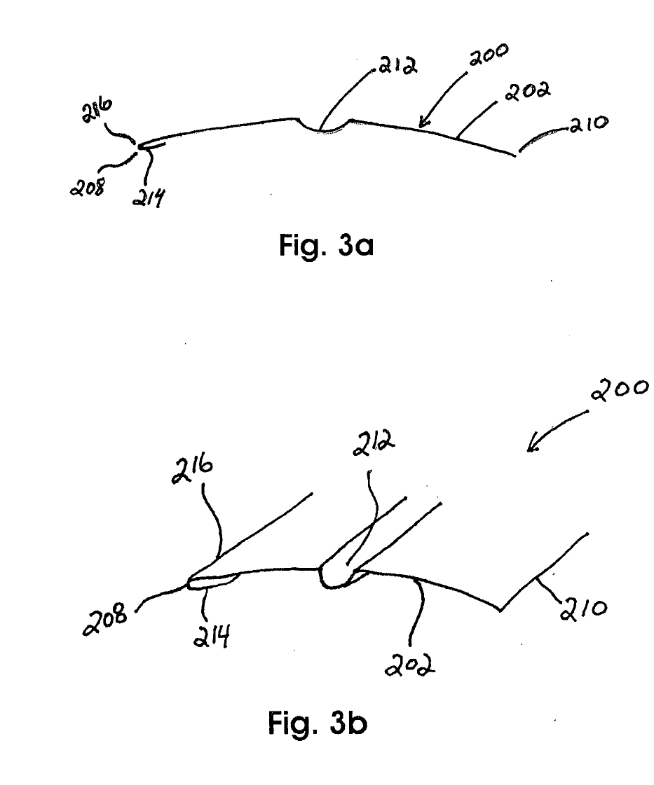

Wing sections 202 of the lower PVC sheet extend laterally away from opposite sides of fuselage section 206 at a predetermined dihedral angle. The wing sections 202 comprise leading edges 208 and trailing 210 edges. The wing sections are vacuum formed with a predetermined airfoil curvature along the lengths or spans of the wing sections between the leading edges 208 and the trailing edges 210 (see FIG. 3a and 3b). The airfoil curvature of the wing sections act as spars that stiffen the wing sections.

To add additional stiffness to wing sections 202, the wing sections are formed with troughs or grooves 212 extending longitudinally from proximate the wing tips to proximate the wing roots. Troughs 212 act as “spars” that stiffen the wing sections. The toughs 212 can be vacuum formed or they can be formed by introducing folds (see FIG. 5) into the wing sections 202. In the embodiment shown in FIGS. 1, 3a and 3b, the troughs 212 are rounded depressions that have been vacuum formed in the upper surface of the lower PVC sheet 200. The troughs 212 are formed where the wing's airfoil is thickest.

In other embodiments, each wing section 202 can be formed with more than one trough 212 and the troughs may comprise different shapes and intersect a wing section's chord at different locations and angles. Particularly in wings having a very low aspect ratio and a long chord, the troughs or grooves 212 may extend parallel to the chord of the wing to form “ribs”, thereby helping to stiffen the wing and establish and hold the airfoil shape in a thin sheet of plastic. In this way, wing sections 202 may be formed with troughs or grooves 212 forming both “spars” and “ribs”. In other embodiments, additional stiffness can be added to wing sections 202 by covering the troughs 212 with tape or a label (not shown).

Lower PVC sheet 200 is optionally formed with small extensions 214 of PVC forward of leading edge 208 of the wing sections. As shown in FIGS. 1, 3a and 3b, small extensions 214 are folded under the wing sections 202 and attached with adhesive to the underside of the wing sections. The folds 216 in the lower PVC sheet and the additional PVC thickness along the leading edge 208 of the wing sections 202 form a spar that stiffens the wing sections. The small extensions 214 can optionally be folded under and attached to the underside of the wing sections 202 with tape.

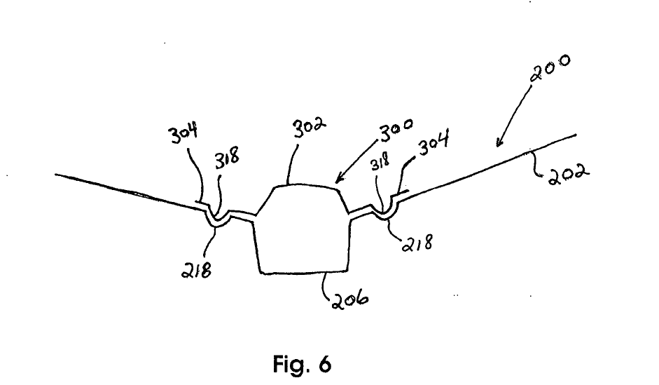

Each wing section may also be formed with circular dimples 218 in the upper surface of the lower PVC sheet 200. In the embodiment shown in FIG. 1, the dimples are adjacent troughs 212 and fuselage 206, but may be placed in other locations. As shown in FIG. 6, dimples 218 or other nesting shapes can be used to provide location during assembly and also to increase stiffness by preventing sliding between the upper 300 and lower 200 sheets.

Tail sections 204 of the lower PVC sheet 200 extend laterally from opposite sides of fuselage section 206. To add additional stiffness to tail sections 204, the tail sections may be formed with troughs 222 similar to those formed in the wing sections 202, described above.

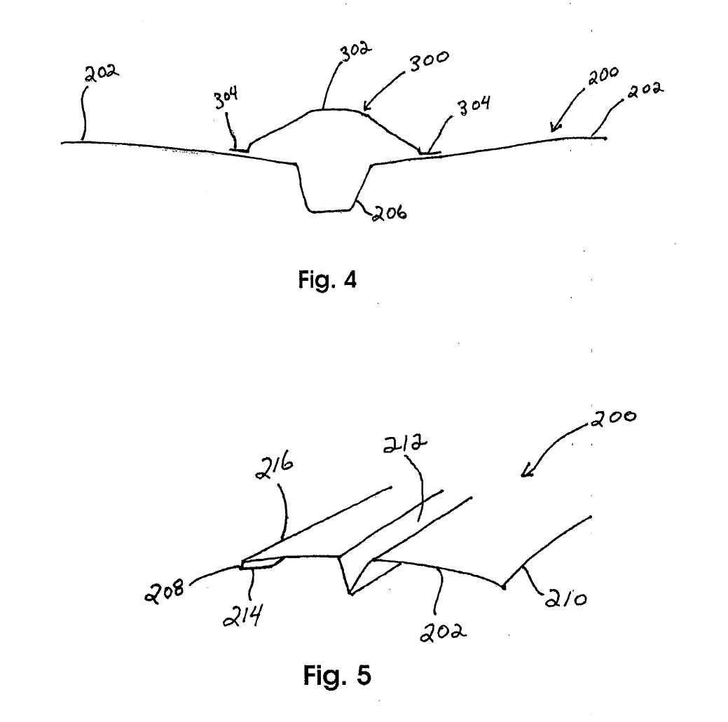

Fuselage section 206 of the lower PVC sheet 200 comprises roughly a half cylinder wherefrom the wing sections 202 and the tail sections 204 extend laterally. Indents, as shown in FIGS. 4 and 6, are formed in of the fuselage section of the lower PVC sheet 200. The indents in the lower PVC sheet 200 define spaces where the airplane's internal components can be easily placed and secured in an exact location and alignment. The internal components can include motors, capacitors, landing gears, batteries, and the like. In other embodiments, the internal components can be held in place by a foam bulkhead, or stuck to lower PVC sheet 200 with adhesive.

With reference to FIG. 2, upper PVC sheet 300 is a continuous sheet comprising a fuselage section 302 and an attachment flange 304. Reverse printed on the lower surface of upper PVC sheet 300 are photographically detailed images 330 that can be seen through the plastic. The images depict elements common to the topside of an airplane. In other embodiments, the upper PVC sheet 300 is not printed on and is substantially transparent. Indents, as shown in FIGS. 4 and 6, for holding the airplane's internal components are formed in the fuselage section 302 of the upper PVC sheet similar to those formed in lower PVC sheet 200, described above.

As shown in FIG. 6, the lower surface of attachment flange 304 of the upper PVC sheet is vacuum formed to match the profile of the upper surface of lower PVC sheet 200. In particular, circular dimples 318 are formed in the upper PVC sheet 300. Dimples 318 are adapted to mate with dimples 218 formed in the lower PVC sheet 200. The dimples 218, 318 or other nesting shapes can be used to provide location during assembly and also to increase stiffness by preventing sliding between the upper 300 and lower 200 sheets

The two PVC sheets 200, 300 are joined to form the vehicle body of airplane 100. The upper surface of lower PVC sheet 200 is joined to the lower surface of attachment flange 304 of upper PVC sheet 300. The sheets are joined by adhesive, ultrasonic sealing, heating of the surfaces of the PVC sheets or other means known to persons skilled in the art. Any excess material around the joined surfaces of the two sheets is trimmed.

After the two PVC sheets are joined, the fuselage sections 206 of the lower PVC sheet and fuselage section 302 of the upper PVC sheet form a rigid, roughly tubular body that serves as the fuselage of airplane 100. Attachment flange 304 is flush with the upper surface of lower PVC sheet 200, including portions of troughs 212, 222 formed in the wing and tail sections. Dimples 318 of the upper PVC sheet 300 are mated with dimples 218 of the lower PVC sheet 100.

The fuselage section 302 and the attachment flange 304 of upper PVC sheet 300 also extend over a portion of wing sections 202 of lower PVC sheet 200. This overlap of the upper PVC sheet 300 over the wing sections 202 provides additional support for the wing sections and their dihedral angle.

With reference to FIG. 1 and airplane 100, a vehicle body of the lightweight plastic vehicle as described herein is generally manufactured in the following steps.
1) Images 230 are reverse printed on a surface of a first sheet of PVC.
2) Lower PVC sheet 200 is formed by at least one of folding or vacuum forming the first sheet of PVC.
3) Excess PVC is trimmed from lower PVC sheet 200.
4) Images 330 are reverse printed on a surface of a second sheet of PVC.
5) Upper PVC sheet 300 is formed by at least one of folding or vacuum forming the second sheet of PVC
6) Excess PVC is trimmed from upper PVC sheet 300.
7) Lower PVC sheet 200 and upper PVC sheet 300 are joined.
8) Any excess material around joined surfaces of the lower and upper PVC sheets is trimmed.
9) Internal components (not shown) of airplane 100 are placed and secured between fuselage sections 206, 302 of the upper 300 and lower 200 PVC sheets before or after the two PVC sheets are joined.

The steps of forming the lower sheet 200 and the upper sheet 300 may also include the step of forming one or more curves, folds or troughs into the plastic sheets to stiffen the sheets.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A lightweight vehicle comprising:
a vehicle body;
wherein said vehicle body comprises at least one sheet of plastic, said plastic sheet made from one of polyvinylchloride plastic, polycarbonate plastic, butyrate plastic and a combination of polyvinylchloride plastic, polycarbonate plastic, and butyrate plastic.

2. The vehicle of claim 1 wherein said vehicle body is formed by at least one of folding or vacuum forming.

3. The vehicle of claim 1, wherein said at least one sheet of plastic is between about 0.005 and 0.015 inches thick.

4. The vehicle of claim 1, wherein said at least one sheet of plastic is between about 0.005 and 0.05 inches thick.

5. The vehicle of claim 1, wherein a stiffness modulus of said at least one sheet of plastic is in a range of between about 306,000 psi and about 414,000 psi.

6. The vehicle of claim 1, wherein said at least one sheet of plastic is transparent.

7. The vehicle of claim 6, wherein at least one image is reverse printed on said at least one sheet of plastic.

8. The vehicle of claim 1, wherein said at least one sheet of plastic comprises at least one fold, said at least one fold stiffening said at least one sheet.

9. The vehicle of claim 1, wherein said at least one sheet of plastic comprises at least one vacuum formed curve, said at least one vacuum formed curve stiffening said at least one sheet.

10. The vehicle of claim 1, wherein said at least one sheet of plastic comprises indents adapted to receive the vehicle's internal components and hold them in a predetermined location and alignment.

11. The vehicle of claim 1, wherein said at least one sheet of plastic comprises at least one trough, said at least one trough stiffening said at least one sheet.

12. The vehicle of claim 11, wherein said at least one trough is at least partially covered by tape or a label.

13. The vehicle of claim 1, wherein said vehicle body comprises a first sheet of plastic and a second sheet of plastic, said first sheet formed into a first portion of the vehicle body, said second sheet formed into a second portion of the vehicle body,
wherein said first and second portions are joined to form said vehicle body.

14. The vehicle of claim 13, wherein said first and second portions overlap where there are points of flexure in the vehicle body.

15. The vehicle of claim 13, wherein said first and second portions are formed with nesting shapes adapted for aligning and joining said first and second portions.

16. The vehicle of claim 1, wherein said vehicle is an airplane,
wherein said at least one sheet of plastic is formed into:
a) left and right wing sections;
b) left and right tail sections; and
c) a fuselage.

17. The vehicle of claim 16, wherein said vehicle is a ready to fly airplane.

18. The vehicle of claim 16, wherein said wing sections are formed with at least one trough, said at least one trough stiffening said wing sections.

19. The vehicle of claim 16, wherein said tail sections are formed with at least one trough, said at least one trough stiffening said tail sections.

20. The vehicle of claim 18, wherein said at least one trough is at least partially covered by one of tape and a label.

21. The vehicle of claim 19, wherein said at least one trough is at least partially covered by one of tape and a label.

22. The vehicle of claim 16, wherein a fold in said at least one sheet of plastic defines leading edges of said wing sections, said fold stiffening said wing sections.

23. The vehicle of claim 16, wherein a curve is formed in said at least one sheet of plastic adjacent to leading edges of said wing sections, said curve stiffening said wing sections.

24. The vehicle of any claim 16, wherein said vehicle body comprises a first sheet and a second sheet of plastic, said first sheet formed into a first portion of the vehicle body, said second sheet formed into a second portion of the vehicle body,
wherein said first and second portions are joined to form said vehicle body.

25. The vehicle of claim 24, wherein said first and second portions overlap where said wing sections meet said fuselage.

26. A method of manufacturing a lightweight vehicle comprising the steps of:
forming a first sheet of a plastic into a first portion of a vehicle body;
forming a second sheet of said plastic into a second portion of a vehicle body;
securing internal components of said vehicle between said first portion of the vehicle body and said second portion of the vehicle body; and
joining said first and second portions of the vehicle body; wherein said plastic sheets are made from one of polyvinylchloride plastic, polycarbonate plastic, butyrate plastic, or combinations thereof.

27. The method of claim 26, wherein said first and second portions of said vehicle body are formed by at least one of folding and vacuum forming.

28. The method of claim 26, wherein the steps of forming said first sheet and/or said second sheet include the step of forming at least one curve in said first sheet and/or said second sheet to stiffen said first sheet and/or said second sheet.

29. The method of claim 26, wherein the steps of forming said first sheet and/or said second sheet include the step of forming at least one fold in said first sheet and/or said second sheet to stiffen said first sheet and/or said second sheet.

30. The method of claim 26, wherein the steps of forming said first sheet and/or said second sheet include the step of forming at least one trough in said first sheet and/or said second sheet to stiffen said first sheet and/or said second sheet.

31. The method of claim 26, wherein said first and second sheets of plastic are between about 0.005 and 0.015 inches thick.

32. The method of claim 26, wherein said first and second sheets of plastic are between about 0.005 and 0.05 inches thick.

33. The method of claim 26, wherein a stiffness modulus of said first and second sheets of plastic is in a range of between about 306,000 psi and about 414,000 psi.
